(19) United States
(12) Patent Application Publication
(10) Pub. No.: US 2005/0220940 A1
(43) Pub. Date: Oct. 6, 2005

(54) Process for the production of edible coated cores and cores produced by the process

(76) Inventors: Ian Fairs, Wallington (GB); James Dedman, Buckinghamshire (GB)

Correspondence Address: SCULLY, SCOTT, MURPHY & PRESSER;400 GARDEN CITY PLAZA, GARDEN CITY, NY, 11530, US

(21) Appl. No.: 10/503,551

(22) PCT Filed: Dec. 2, 2003
(86) PCT No.: PCT/FI03/00918

§ 371 Date: Mar. 11, 2005

(30) Foreign Application Priority Data
Dec. 3, 2002 (FI) 20022130

(51) Int. Cl. A23G 3/30

(52) U.S. Cl. 426/89; 426/3; 426/548

(57) ABSTRACT

The invention relates to a process for the production of cores coated with lactitol. The process produces a compact, continuous, stable and crunchy coating of crystalline lactitol on a chewable core by causing the lactitol to crystallize in a lactitol monohydrate-like form. The invention also relates to the lactitol coated products obtained by the process, such products comprising chewing gums, tablets, candies, almonds, and the like.

The present invention relates to a process for the production of cores coated with lactitol. The invention relates especially to the production of a compact, continuous, stable and crunchy coating of crystalline lactitol on a chewable core. The invention also relates to the lactitol coated products obtained by the process, such products comprising chewing gums, tablets, candies, almonds, etc.

Lactitol is a sweetener which can be used as a total or partial replacement for sucrose. Its energy content is only about half of that of sucrose, and it does not cause increased blood glucose content. Furthermore, it is non-cariogenic and hence tooth-friendly. Crystalline lactitol has been used as a sweetening agent in dietetic products, confectionery, bakery products, cereals, desserts, jams, beverages, chocolate, chewing gums and ice-cream. Crystalline lactitol may also be used in the manufacture of pharmaceuticals and functional foods.

It is well documented that lactitol has an unusually complex crystallization behavior. Lactitol has been found to crystallize in anhydrous (so called B or A2) form having a melting range of 149-152° C. (U.S. Pat. No. 5,494,525). Lactitol is further reported to have another anhydrous form (so called A or A1) melting at about 124° C. (K. Yajima, Chem. Pharm.Bull.45(10) 1677-1682 (1997)). The A1 anhydrous form is produced by drying crystalline lactitol and it is not thought to be stable. Lactitol is additionally capable of crystallizing in the monohydrate form melting in the range of 94-100° C. as described in EP Patent 456636. A product called “lactitol monohydrate” but having the melting point of 121-123° C. is reported as being produced in EP Patent 39981. However, it has been shown that 121-123° C. is not the melting point of lactitol monohydrate but that of the anhydrous A1 lactitol. Under the same conditions said EP patent 39981 produces a “lactitol dihydrate” having a melting point of 82-85° C. On the other hand, researchers (J.Kivikoski et al., Carbohydrate Research, 233 (1992), 53-59) report that the true dihydrate has a melting point of 70-72° C. Lactitol trihydrate is reported in EP 381483 as having a melting range of 52-56° C.

U.S. Pat. No. 6,402,227 describes methods which can be used for selectively crystallizing the various lactitol crystal forms from an aqueous solution of lactitol. As described in said US Patent, lactitol is also capable of precipitating into a solid mass which contains a random structure of crystal-like lactitol-water structures depending on the crystallization conditions. Such a random mixture of crystal-like structures is generally not stable as at least some of the solids tend with time to change into other solid lactitol forms.

Panning is a process for coating of cores with a hard layer of a material, typically a sweetener. The art of coating or panning is described generally e.g. in the article “Crystallisation and drying during hard panning” by Dr. Richard W. Hartel in Manufacturing Confectioner, February 1995, p. 51-57. The most common material used for panning is sucrose. However, polyols such as xylitol and sorbitol have also been suggested as coating materials even though they behave differently from sucrose as described by Francis Devos in his article “Coating with sorbitol. A Comparison of properties of sorbitol-mannitol, other polyols and sugars”, Manufacturing Confectioner, November 1980, p.26-32.

A large number of references also mention that lactitol can be used similarly to other polyols in place of sucrose for panning. Such references include a vast number of Patents assigned to Wrigley J R and disclosing a wide range of optional conditions which may be used for providing lactitol in a coating. Such Patents include U.S. Pat. No. 5,376,389; U.S. Pat. No. 5,665,406; U.S. Pat. No. 5,952,019; EP 719092; EP 746208; WO 95/07621; WO 95/07622, etc. Said Patents have not been found to disclose the true character of the coating nor have any stability data of the coatings been given. Considering the complexity of the lactitol crystallization behavior it is not believed that the said Patents enable a person skilled in the art to select the specific conditions needed for providing with certainty a good quality stable lactitol coating.

Purac Biochem was the first to commercialize lactitol in the “lactitol monohydrate” from produced according to its EP Patent 39981 mentioned above. In the early 1990ies Purac Biochem published a leaflet called “LACTY HARD PANNING” (undated), describing the use of lactitol in the hard panning of centres with a solution of lactitol at 25° C. and drying with a drying air at 20-25° C. The coated centres should be stored for at least twelve hours at a temperature below 25° C. The publication did not result in the commercial use of lactitol as a coating in hard panning and attempts to repeat the procedure resulted in poor quality instable coatings. It is believed that the low temperature and high concentration of the solution caused lactitol dihydrate nuclei to form in the solution causing the lactitol to crystallize in a dihydrate-like form on the cores.

U.S. Pat. No. 5,571,547 discloses a method for producing a polyol coating in fewer steps by spraying polyol syrup and polyol powder in the coating cycles of the coating procedure. Although lactitol is suggested for coating, there are no examples on the use of lactitol.

JP-A-4281748 describes a hard-coated product mainly consisting of lactitol. A low hygroscopicity coating is said to be produced by applying a lactitol syrup of 45-85% by weight and a temperature of no more than 60° C. directly on the cores. The sprayed cores are dried with air at no higher than 70° C. A large number of the tests are performed under conditions thought to favour dihydrate-like crystallization. The stability of the products was not tested.

The present process is based on controlling the procedures relating to standard hard panning procedures so as to reproducibly obtain a smooth, compact and stable lactitol coating. Such standard procedures comprise the steps of introducing [chewable] cores which are to be coated into a coating pan or drum; rotating the cores in the pan or drum; spraying a syrup containing dissolved lactitol over the rotating bed of cores; drying the sprayed cores with a flow of air so as to cause the lactitol to crystallize as a thin layer on the cores; and repeating the above rotating, spraying and drying steps until a desired thickness of lactitol coating has been obtained on the cores.

As noted above, there is an abundance of different pure lactitol crystal forms and lactitol is also capable of precipitating in a random mixture of various lactitol-water structures. None of the other polyols used for hard panning have such a complex crystallization behavior. None of the prior art literature references suggest any specific measures to be taken to provide any certain form of lactitol crystals. The complexity of the lactitol crystallization is thought to be one of the reasons why lactitol has been considered unpredictable as a coating material and why lactitol has not so far reached the stage of being commercially utilized as a coating material.

The various solid forms of lactitol which may form during a conventional panning procedure have different characteristics, different stability and different hygroscopicity. A good coating should be smooth, compact and stable. It should have a very low hygroscopicity to stay crisp and crunchy and it must not deteriorate due to moisture or migration of compounds during storage.

Lactitol coatings produced when testing the prior art methods have generally been of poor quality. There have been problems with a certain graininess especially at storage. The coatings have been porous and the crystals have been too large for coating purposes. The human mouth is very sensitive and is capable of feeling discrete crystals if their size is about 20μ or more.

Some of the coatings have looked fine just after panning but have deteriorated in storage so that any initial crispness has disappeared and has turned into a grittiness. This has been true especially for the coating of cores wherein the sweetener has been other than lactitol. Sometimes the layers have become gritty or sandy due to crystal growth during storage.

It has now been found that if the conditions of the panning are set so that the crystallization favours the formation of lactitol monohydrate-like crystals rather than the dihydrate and anhydrous lactitol forms, then the coating will be smooth, compact and stable. The lactitol monohydrate-like crystals, provided that it is initially crystallized in the lactitol monohydrate-like form, will surprisingly be stable and will not deteriorate during storage. It has also been found that any migration of non-lactitol compounds may be prevented by a protective layer on the core.

The present invention is defined in the appended claims which are incorporated herein by reference.

The present invention relates to an improvement in the hard panning of lactitol wherein lactitol is caused to crystallize in a lactitol monohydrate-like form and is caused to retain its monohydrate-like form in order to provide a smooth, compact, continuous and stable coating of crystalline lactitol and in order to prevent deterioration of the coating at storage.

The present invention also refers to products obtained by the process, i.e. cores coated with a hard coating of lactitol, wherein said lactitol coating comprises a smooth and compact continuous layer of crystalline lactitol which has crystallized during the coating process in a lactitol monohydrate-like form for providing stability of the coating and for preventing deterioration of the coating at storage. The cores may be cores such as chewing gum, tablets, candies and the like. The preferred cores are chewing gum centres.

The present invention is described in greater detail below and illustrated by the appended Figures, wherein

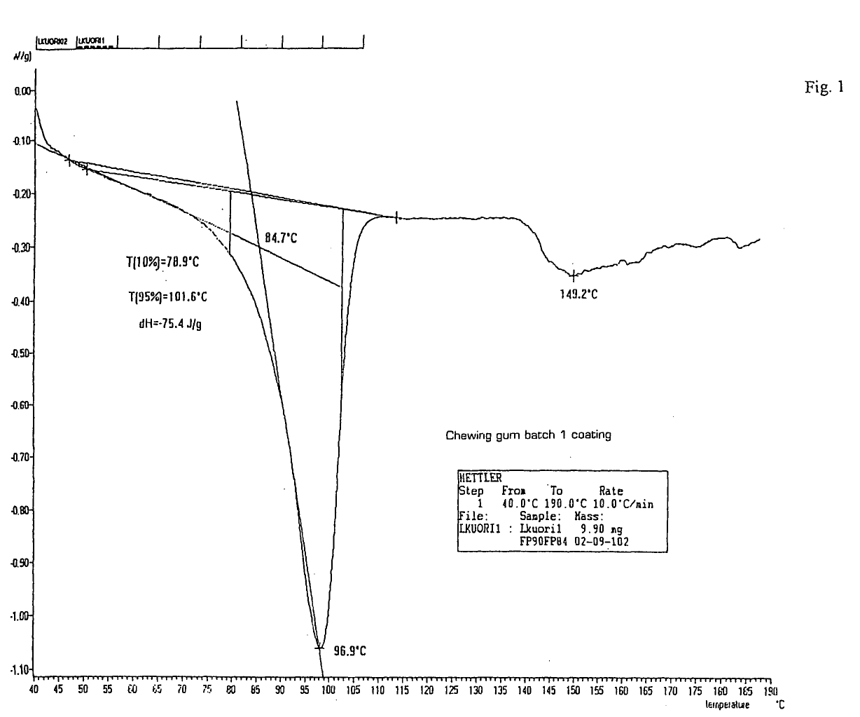

FIGS. 1 to 3 show DSC diagrams of lactitol coatings,

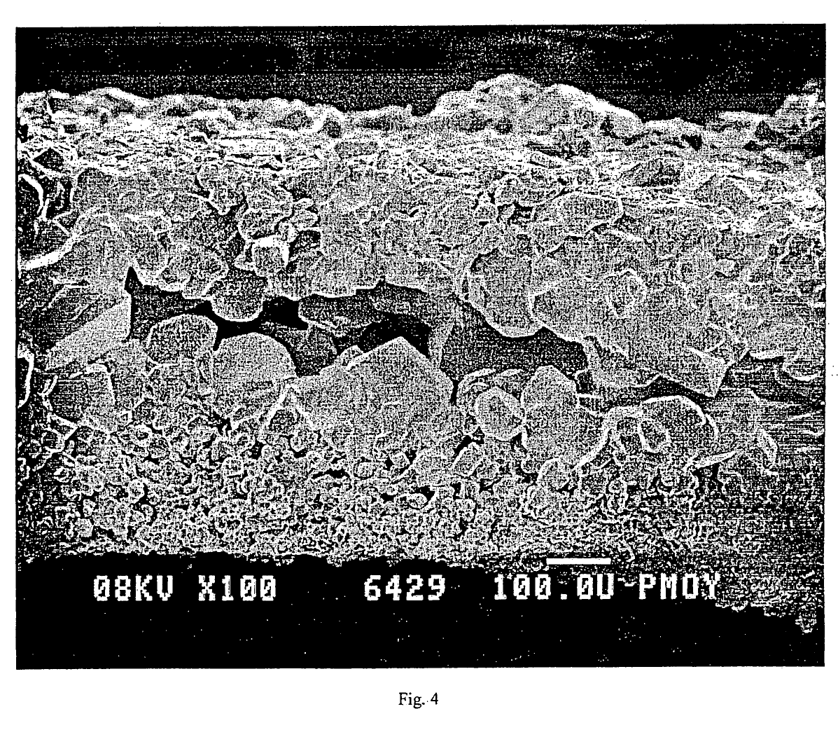

FIGS. 4 to 6 show SEM photographs taken in 100× magnification of products coated with lactitol, and

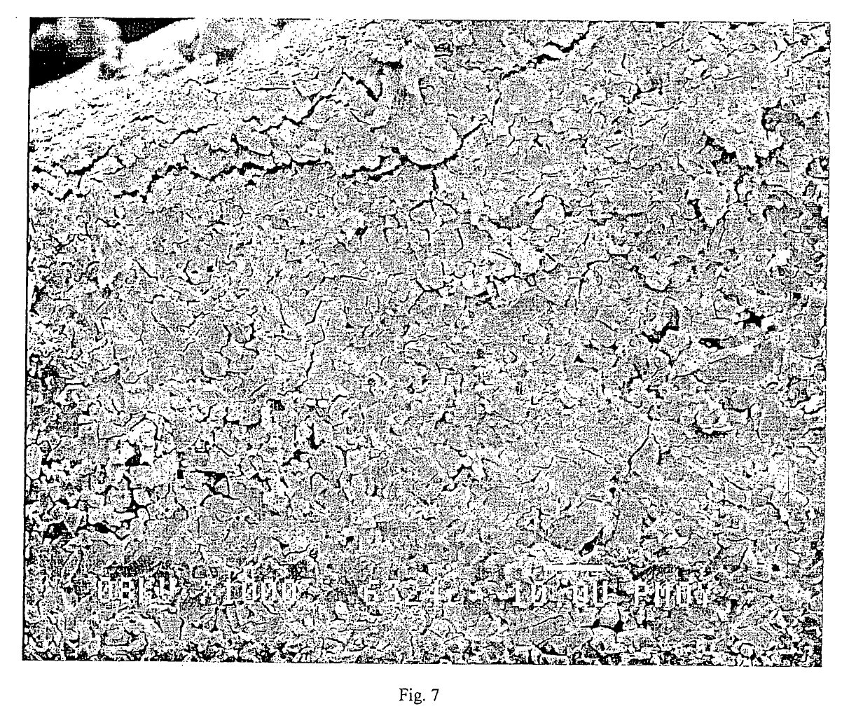

FIG. 7 shows a SEM photograph taken at 1000× magnification of a product coated with lactitol.

The term “pure lactitol monohydrate” or “true lactitol monohydrate” as used in the present specification and claims is intended to mean lactitol monohydrate having a melting range between 94 and 100° C. and having the cell unit constants as defined in the above mentioned EP Patent 456636. It contains about 5% water and has a single narrow peak at around 100° C. measured by Differential Scanning Calorimetry (DSC) at 10° C./min (see H.Halttunen et al., Thermochimica Acta, 380 (2001) 55-65).

The term “lactitol monohydrate” when used alone in the present specification and claims denotes a crystalline lactitol compound which includes lactitol monohydrate and is commercially provided under that heading irrespective of whether it fulfils all of the strict criteria of the pure lactitol monohydrate of the above mentioned EP Patent 456636 or not.

The terms “lactitol monohydrate-like” form or crystal and “monohydrate-like lactitol” as used in the present specification and claims is intended to mean crystallized lactitol which in some properties resembles pure lactitol monohydrate but which is generally not pure lactitol monohydrate. The term “resembles” lactitol monohydrate indicates that even though the crystal mass may contain structures of lactitol, water and other components, which structures are not identical with those of pure lactitol monohydrate, these structures resemble lactitol monohydrate more than they resemble any of the other known crystal forms of lactitol. The monohydrate-like lactitol specifically resembles pure lactitol monohydrate in having one significant peak in a DSC diagram in substantially the same position (around 100° C.) as pure lactitol monohydrate, measured at 10° C./min. The monohydrate-like lactitol specifically lacks any peaks in the DSC diagram at the position indicating dihydrate (75-85° C.). Any DSC peaks indicating the presence of anhydrous Al lactitol (120-130° C.) should be minimal compared to the significant peak indicating monohydrate. The most stable coatings have been found to have no noticeable peak at all in the A1 anhydrous range. Thus, the monohydrate-like lactitol contains less than 5%, preferably less than 2%, most preferably less than 1% by weight of lactitol dihydrate and/or anhydrous A1 lactitol.

It should be noted that measurements on lactitol crystals by DSC are apt to give slightly different results depending how the measurement was performed. Thus, the exact position of the peaks depends on factors such as the speed of measurement, the temperature range, the amount of sample, the pre-treatment of the sample, the cup (open or closed), etc. Moreover, the amount of anhydrous forms may increase during the measurement itself due to drying of the sample. However, DSC still provides a very good indication of the character of the sample.

The monohydrate-like lactitol may have a water content which is different from that of pure lactitol monohydrate (5%). It is a typical feature of polyol coatings that they include a certain amount (e.g. 1-5%) of free water, and this is also true for the coatings composed of the present monohydrate-like lactitol. Coatings having from 5.5 to 8.5% water have been found to be stable provided that they have been produced according to the present invention. The free water should not be confused with the water contained in lactitol dihydrate as crystal water. However, a part of the extra water may be contained in amorphous lactitol included as part of the coating.

The monhydrate-like lactitol of the present invention has a drying behaviour resembling that of pure lactitol monohydrate. In other words, it looses essentially all of its water when dried at 130° C. for a few hours. This is in contrast to the “lactitol monohydrate” crystal obtained in EP Patent 39981 mentioned above which looses only 2% of its moisture when dried at 130° C. for three days.

The monohydrate-like lactitol should be essentially free of other polyols such as sorbitol and xylitol. Thus, the lactitol monohydrate-like coating should contain less than 1%, preferably less than 0.5% and most preferably less than 0.2% of such other polyols. However, the monohydrate-like lactitol coating preferably contains about 2-5% and up to 10-15% by weight of other components such as crystallization modifiers, intense sweeteners, pigments, etc. as long as they do not interfere with the crystal structure in such a way as to distort the structure providing the significant monohydrate peak. The enthalpy (as measured by DSC) of the monohydrate-like lactitol depends on the amount and kind of other components included in the layer. However, the enthalpy is generally much below that of pure lactitol monohydrate.

The term “smooth” coating as used in the present specification and claims denotes a lactitol coating which forms a visibly uniform sheet on the cores and which has a pleasant mouthfeel which lacks grittiness or coarseness.

The term “compact” coating as used in the present specification and claims denotes a lactitol coating which is non-porous and which forms a dense mass of minute crystals firmly adhered together. The crystals have a mean particle size below 20 μm and preferably below 51 μm.

The term “continuous” coating as used in the present specification and claims denotes a lactitol coating wherein the crystals which have formed in the panning procedure are so tightly joined together that they seem to form a continuous phase rather than a mass of crystals even when viewed in 100× magnification.

The term “stable” coating as used in the present specification and claims denotes a lactitol coating which retains its lactitol monohydrate-like character and its outer properties during the normal shelf life of the product.

The terms “crisp” and “crunchy” coating as used in the present specification denotes a lactitol coating which has a hard, yet brittle mouthfeel as it breaks when the coated product is chewed.

In one aspect of the invention, the lactitol in the syrup is caused to crystallize in the monohydrate-like form by providing a crystallization modifier to the syrup before spraying. The crystallization modifier is added to retard the crystallization of the lactitol and in order to allow it to spread evenly onto the core and to get into contact with the lactitol monohydrate seed crystals present in the underlying layer(s). If crystallization is too quick, the lactitol may crystallize in an uncontrolled manner which may result in impure crystal structures, too large single crystals, enclosed liquid in the layer, etc. The crystallization modifier may also have film forming properties which helps spread the solution over the core.

The crystallization modifier must not interfere with the formation of the crystals in such a way as to disturb the structure of the monohydrate-like lactitol. Preferred crystallization modifiers are gum arabic, gum thala, and gelatine. Further acceptable modifiers are other gums such as guar gum, locust bean gum, xanthan gum, gellan gum as well as alginates, carageenan, pectin or celluloses (CMC, HPMC, HEC), etc.

The crystallization modifiers are generally added to the syrup in an amount of about 1 -10%, preferably 2-5% calculated on the weight of the syrup. The initial layers of lactitol may be produced with a higher modifier content, up to about 20%, to ensure that the initial crystallization is correct and to reduce interaction with harmful components in the core. The syrup may also contain other additives such as flavours, pigments, special sweeteners, active ingredients, etc. The additives should be chosen so as not to adversely affect the crystallization process. Good results have been obtained with titanium dioxide as a pigment and Aspartame and Acesulfame K as intense sweeteners in the coating solution.

In another aspect of the present invention, the monohydrate-like lactitol which has been formed in the panning is caused to retain its monohydrate-like form by preventing migration of coating-deteriorating compounds from the core into the coating. It has been found that in case the core contains other sweeteners than lactitol, such as sugars or other polyols, the coating will deteriorate due to a migration of such compounds from the core into the coating. The monohydrate-like lactitol should be essentially free of other sugars and polyols in order to be stable.

Most of the migration seems to take place during the panning itself. In such a case even a seemingly good quality coating will be found to be impure in crystal structure and the coating will deteriorate with time. This has been found to be especially so when the core contains another polyol such as xylitol or sorbitol. The fact that these polyols cause the lactitol coating to deteriorate indicates that the dual polyol coatings suggested in the prior art are not likely to be stable.

Some ingredients of the core, such as glycerine may migrate out from the core even though the initial coating has crystallized in a proper monohydrate-like form. Such compounds may with time cause the lactitol monohydrate-like layer to deteriorate.

In order to protect the lactitol monohydrate-like layer from deteriorating, such migration is prevented, according to the invention, by precoating the cores with a protective layer prior to the lactitol coating. The precoating should create a moisture barrier on the cores to prevent the moisture applied in the coating syrup from dissolving polyols etc. from the cores. The precoating is preferably performed in the pan or drum prior to starting the spaying of lactitol.

Preferred protective compounds for the precoating comprise gum arabic, gelatine and shellac. The compounds suggested above as crystallization modifiers may also be used for precoating. Additionally fats such as cocoa butter can be used in certain applications. The amount of precoating material varies with the individual material used. When the preferred compound, gum arabic, is used as the protective layer, a suitable concentration of the gum arabic solution is 30-50% by weight of the solution.

In order to control the crystallization and ascertain that the crystal structure is regulated into the lactitol monohydrate-like form, the precoated cores are preferably dusted with a powder containing lactitol monohydrate before spraying said lactitol syrup onto the cores. The powder preferably consists of seed crystals obtained by milling pure lactitol monohydrate. The precoated cores also tend to be rather sticky before the protective coating has dried and the powder also assists in preventing the cores from sticking together. The coating is then dried before the lactitol syrup is sprayed onto the cores. Sticking of the cores may take place also though no precoating is applied, and dusting of the sprayed cores may be performed to reduce sticking. The dusting material preferably comprises lactitol monohydrate.

In case the sweetener of a core, such as a chewing gum centre, is lactitol monohydrate, precoating of the core is not necessary, as this lactitol monohydrate will remain essentially intact in the gum centres and it will act as a template for the crystallization of the first layer of lactitol being sprayed onto the cores. The lactitol monohydrate in the core preferably comprises pure lactitol monohydrate for controlling the crystallization.

The temperature of the lactitol syrup should be rather high, since a high temperature of the solution directs the crystallization towards the lactitol monohydrate-like form and away from the dihydrate, which predominantly crystallizes at lower temperatures. When lactitol is crystallized out from an aqueous solution, the ideal temperature for lactitol monohydrate production is 53 to 69° C. as disclosed in the above mentioned U.S. Pat. No. 6,402,227. However, the present crystallization differs from such a crystallization in that in the panning process all of the water evaporates and all of the lactitol and other components included in the syrup form the solid layer. In a crystallization in an aqueous solution, the water remains and pure lactitol crystals solidify from the solution. In a panning process it is more difficult to keep the crystallizing solution under constant crystallization conditions. Therefore, the quality of the seed crystals and the quality of each previous coating layer is of the utmost importance in the panning process.

It has been found that the temperature of the lactitol syrup should preferably be adjusted to between 50 and 70° C., more preferably between 53 and 65° C., most preferably between 55 and 60° C. in order to cause the lactitol to crystallize in the monohydrate-like form. Care should, however, be taken to keep the temperature low enough so as not to harm the cores being coated. The initial layers should be sprayed with just sufficient solution to evenly coat the cores. As the coating builds up, the syrup addition may be slightly increased. The final few spray additions should again be reduced in order to give a smooth coating.

Each sprayed layer of lactitol syrup is dried with a flow of drying air. The temperature of the drying air should be selected so as to facilitate the drying and to cause the lactitol to crystallize in the monohydrate-like form. If a too high temperature is used, the evaporation is too quick and the risk for unwanted precipitation into random mixtures of lactitol-water structures or drying into the instable anhydrous A1 form is increased. It has been found that the temperature of the drying air should be adjusted to between 20 and 50° C., preferably between 25 to 40° C., most preferably to about 25° C. in order to cause the hot lactitol syrup to crystallize in the monohydrate-like form.

Provided that the crystallization proceeds on a solid layer directing the crystallization towards the monohydrate-like form, the drying may be speeded up by drying with air having a relative humidity below RH 50%. In some instances the relative humidity of the drying air may be even lower.

The concentration of the lactitol in the syrup also influences the crystallization process. It has been found that the lactitol concentration of the lactitol syrup should preferably be between 55 and 70%, preferably between 60 and 65% calculated on the weight of the syrup in order to provide good quality lactitol monohydrate-like coatings. The concentration should not be lower than 55%.

In a preferred aspect, the present invention concerns a process for the hard panning of chewable cores in a pan wherein a syrup of lactitol and crystallization modifier is intermittently sprayed over a bed of the cores and the cores are dried between sprayings with a flow of air. The panning process is controlled to cause the lactitol to crystallize into a lactitol monohydrate-like form.

The preferred process may be described as comprising the following steps:
providing chewable cores which contain as a sweetener either lactitol monohydrate or another sweetener such as sucrose, xylitol or sorbitol;
introducing the cores into a coating pan or drum and rotating the cores in said pan or drum;
in case the sweetener is not lactitol monohydrate, precoating the cores with an aqueous gum arabic solution and adding a powder obtained by milling pure lactitol monohydrate onto the precoated cores;
drying the precoating layer with a flow of drying air;
spraying a syrup containing dissolved lactitol and gum arabic at a temperature of 50 to 70° C. over the rotating bed of cores;
drying the sprayed cores with a flow of dry air having a temperature of 20 to 50° C. so as to cause said lactitol to crystallize as a thin layer of lactitol monohydrate-like crystals on said cores; and
repeating the above spraying and drying steps until a desired thickness of a smooth and compact continuous and non-deteriorating lactitol monohydrate-like coating has been obtained on the cores.

The panned cores may at need be tempered in a storage tank and polished in any conventional way before packing.

The following examples illustrate the coating according to the present invention.

### EXAMPLE 1 (Prior art)

A batch of chewing gum cores containing lactitol as a sweetener was coated in the laboratory according to the procedures described in the “LACTY^{R} Hard Panning” brochure by Purac Biochem. The cores were placed in a rotary pan and a solution of a 40% by weight gum arabic solution was sprayed onto the cores. In order to reduce the stickiness, the sprayed cores were dusted with a powder obtained by milling lactitol monohydrate crystals. The cores were dried in trays over night at room temperature.

The dried precoated cores were sprayed in the pan with a 60-62% lactitol solution having a temperature of 25° C. The cores were then dried in the pan with air having a temperature of 25° C. The spraying and drying sequences were repeated until a weight increase of 35% had been obtained. The coated cores were stored in dry air at 20° C. for twelve hours before analysing.

The coating initially looked relatively smooth but it soon deteriorated and became very uneven when left to condition. It seems that the low temperatures used had caused at least a substantial part of the lactitol to crystallize in a dihydrate-like form. The combination of a low temperature and a lack of crystallization control seems to have resulted in a rapid and uncontrolled crystal formation. The resulting coating was inhomogeneous and it lacked the crispness found in good quality coatings.

The test was repeated in a scaled up trial using a 70% lactitol syrup for spraying. However, the coating finish was very irregular and it was not smooth as would be the target of the coating procedure. The product lacked crunch and did not form an acceptable coating.

### EXAMPLES 2 to 4 (Coating without precoating)

Three batches of chewing gum cores were coated according to standard coating practices.

| A mixture containing | % by weight of the solution |
|---|---|
| Milled lactitol | 65.0 |
| (Danisco Sweeteners) | |
| Water | 30.35 |
| Gum Arabic | 4.0 |
| (50% solution) | |
| Titanium Dioxide | 0.5 |
| Aspartame | 0.1 |
| Acesulfame K | 0.05 |

was heated to dissolve the ingredients. The syrup was used at 60° C. for spraying the cores in a rotary pan. About 15 to 20 ml of the coating syrup per kg of cores was applied at a time and allowed to spread evenly over the cores. In the first few sprayings a powder obtained by milling pure lactitol monohydrate was dusted over the sprayed cores to reduce sticking of the cores. The cores were then dried with dry air having a temperature of about 25° C. and a relative humidity of about 50%.

The spraying and drying steps were repeated until a weight increase of about 50% had been achieved. The amount of syrup in the final few syrup applications were slightly reduced to give a smoother coating.

The cores comprised the following sweeteners:

Example 2 xylitol

Example 3 xylitol:lactitol

Example 4 lactitol monohydrate

For the analysis ten pellets of each batch were scraped with a sharp knife to peel off the coating. The coatings were analysed by HPLC and DSC. The analysis results are shown in Table 1. The percentages are calculated on dry substance basis (DS). The crystal morphology of the coatings was analysed by scanning electron microscopy (SEM).

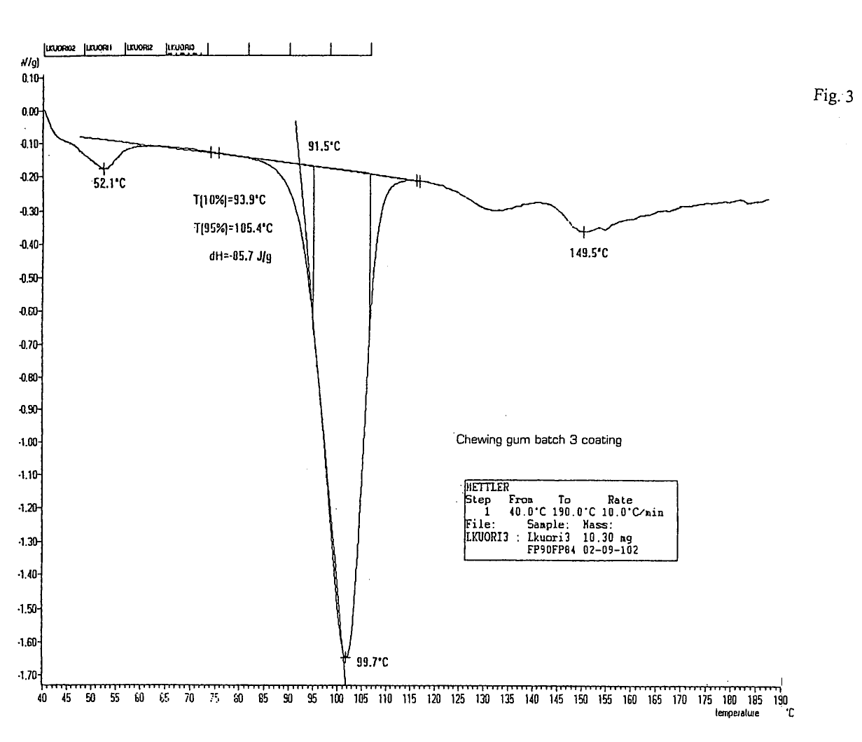

TABLE 1
Analysis results

| Analysis | Example 2 | Example 3 | Example 4 |
|---|---|---|---|
| Core | | | |
| lactitol % on DS | 0.96 | 25.64 | 46.03 |
| xylitol % on DS | 31.68 | 21.1 | 0.63 |
| Coating | | | |
| lactitol % on DS | 85.71 | 90.34 | 92.34 |
| xylitol % on DS | 7.13 | 4.75 | 0.17 |
| DSC | | | FIG.3 |
| peak at ° C. | 96.9 | 100.4 | 99.7 |
| onset at ° C. | 84.7 | 93.8 | 91.5 |
| enthalpy, J/g | 75.4 | 83.8 | 85.7 |

The analysis results indicate that in Examples 2 and 3, some xylitol has leaked from the center into the coating. The coating of Example 4 has no significant amount of xylitol in the coating.

All three coatings looked initially to have a good finish and a good crunch. However, the coatings of Examples 2 and 3 deteriorated with time. After about one week, the coating of

Example 2 was almost peeling off. It was grainy and not smooth. The coating of Example 3 was slightly improved over Example 2 but it also deteriorated in about two weeks.

The coating of Example 4 remained smooth and compact and the layer was continuous and crisp. The product of Example 4 had a good quality lactitol coating. This is believed to be due to the lack of xylitol contamination in the coating while xylitol had clearly migrated into the coatings of Examples 2 and 3.

FIG. 1 shows the DSC diagram of Example 2. The diagram shows a rather broad peak with a long slope starting from about 45° C. It is evident that although the main component of the coating is in the monohydrate-like form, the xylitol which has migrated into the coating has disturbed the crystallization and the crystal structure is not stable.

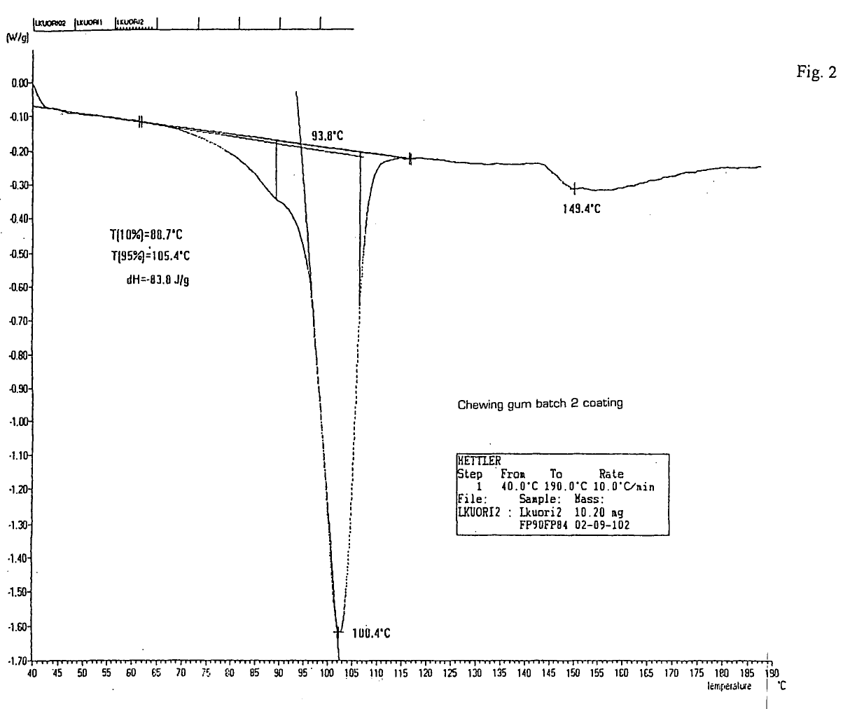

FIG. 2 shows the DSC diagram of Example 3. The diagram shows a narrow peak but a decided “foot” starting from about 60° C. indicates a presence of lactitol dihydrate. Although the main component of the coating is in the monohydrate-like form, the xylitol which has migrated into the coating has disturbed the crystallization and the crystal structure is not stable. It should be noted that some amorphous material can be seen in the SEM photograph. Amorphous material does not show in a DSC diagram.

FIG. 3 shows the DSC diagram of Example 4. The diagram shows a narrow peak with a narrow slope. It is evident that the main component of the coating is in the monohydrate-like form. The peak seen at 52.1° C. may be caused by one of the other ingredients of the syrup.

Traces of anhydrous lactitol A2 melting at 149 to 150° C. can be seen in all three DSC diagrams. Since the A2 form as opposed to the A1 form is rather stable, a small amount of anhydrous A2 does not seem to make the coating instable.

SEM photographs of the three coatings in 100× magnification are shown in FIGS. 4 to 6.

FIG. 4 shows an overall picture of the coating of a fractured chewing gum core according to Example 2. The coating layer shows air holes in the structure. The coating layer contains large crystals on the surface of the coating while smaller crystals are seen at the boundary of the coating and the core.

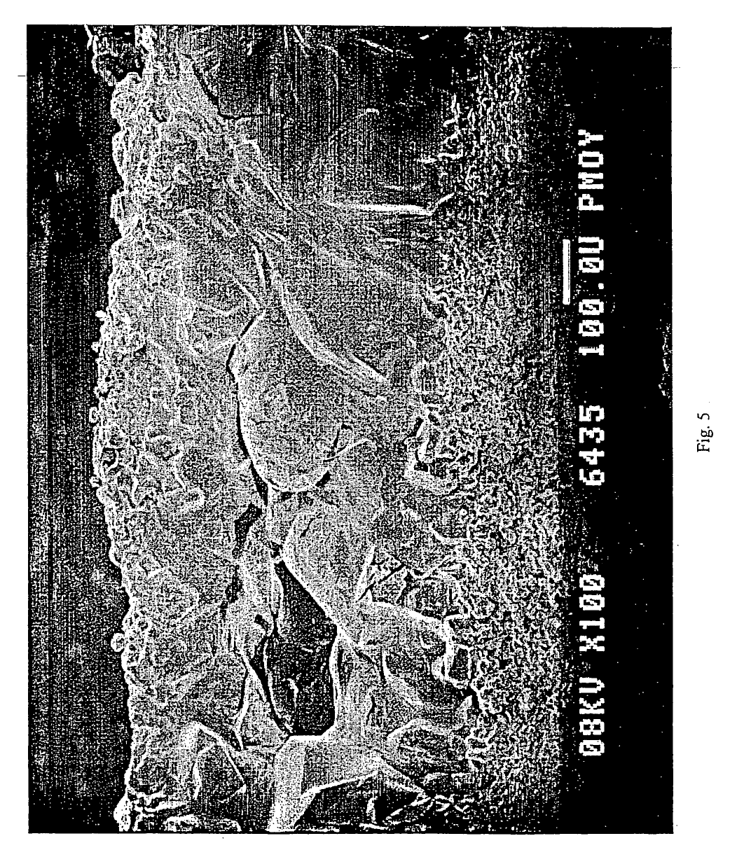

FIG. 5 shows an overall picture of the coating of a fractured chewing gum core according to Example 3. The coating layer shows air holes in the structure. The coating layer looks like an amorphous structure on the surface of the coating while small crystals are seen at the boundary layer between the coating and the core.

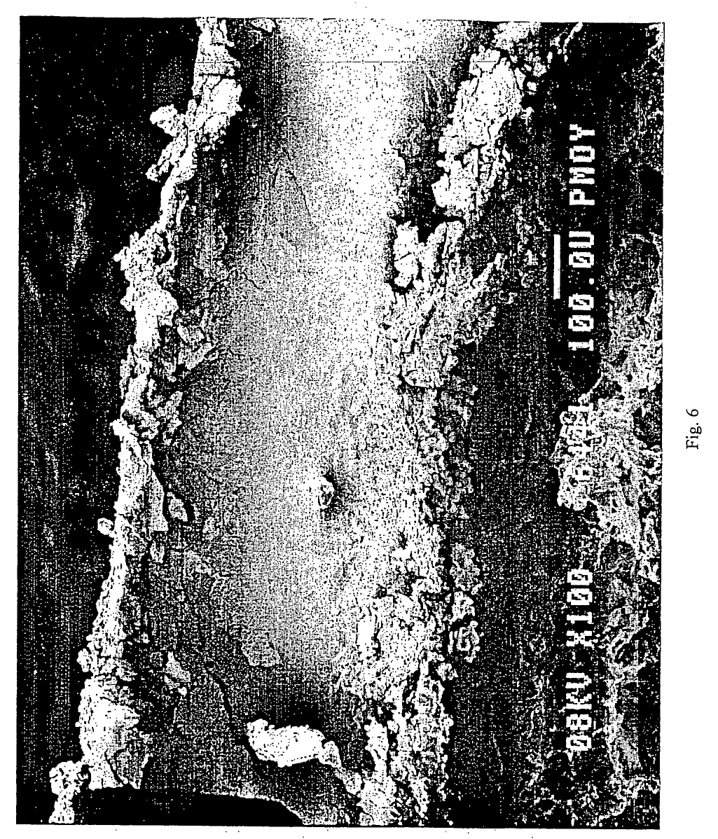

FIG. 6 shows an overall picture of the coating of a fractured chewing gum core according to Example 4. The coating layer shows a compact structure. The coating layer seems to be smooth. The crystal particle size is small and uniform throughout the layer. The boundary layer between the coating and the cores contains crystals of an irregular size and shape.

### EXAMPLE 5 (Coating with precoating)

The procedure of Example 3 was repeated with the exception that the xylitol sweetened core was precoated with a protective layer of gum arabic, which was sprayed as a 50% by weight aqueous solution over the cores, and then dusted with lactitol monohydrate seeds obtained by milling pure lactitol monohydrate (Lactitol Monohydrate, Danisco Sweeteners) to a mean particle size of 50 μm.

The precoated and dusted cores were dried in the pan and then coated with the same syrup as applied in Examples 2 to 4. The temperature of the syrup was 60° C.

The resulting coating was smooth and crisp. The fractured pellets showed a continuous and compact coating with very small crystals tightly adhered together. The layer was stable at storage.

### EXAMPLE 6 (Coating lactitol cores)

A batch of lactitol tablets produced by directly compressing granulated lactitol (Finlac DC tablets, Danisco Sweeteners) were coated with a lactitol syrup containing 65% lactitol monohydrate and 2% gum arabic. The tablets were coated as described in Examples 2-4. The temperature of the lactitol syrup was 60° C. The drying air temperature was 40° C.

The coating was smooth, crisp and compact. The coating kept well at storage and no deterioration of the coating was observed.

A SEM photograph of the coating (FIG. 7) in 1000× magnification indicates that the crystals are generally very small (10 μm or less) and the layer is non-porous and continuous. The SEM photograph also shows the larger lactitol crystals of the tablet core.

### EXAMPLE 7 (Measuring by DSC)

9.8 g of pure lactitol monohydrate (Danisco Sweeteners) and 0.8 g of gum arabic was weighed, combined, mixed and ground slightly in a mortar. The thermal behaviour of the mixture was analyzed with a differential scanning calorimeter (DSC).

9.4 mg of a homogenous sample was put into a 40 microliter aluminium crucible with a pin (ME-27331). The cap of the crucible was not sealed. As a reference a clean crucible with a cap was used. The running conditions were from 40° C. to 190° C. with the heating rate 10° C./minute. Onset was at 93.2° C., peak temperature 103.6° C. and peak enthalpy 163J/g. The DSC used was a Mettler FP90 central processor with a Mettler FP84 hot stage microscopy cell. The data was computed with Mettler FP99 system software.

The result of the DSC run shows that gum arabic does not appreciably change the position of the peak of lactitol monohydrate.

The present invention has been illustrated above by certain specific examples. It is, however, clear that a person skilled in the art can combine the features of the present invention also in other ways in order to obtain a smooth, compact and continuous lactitol monohydrate-like layer, which is stable at storage. Thus, the present invention enables a person skilled in the art to apply lactitol as a good quality coating on edible cores.

1. A process for the production of edible coated cores comprising the steps of introducing cores which are to be coated into a coating pan or drum; rotating said cores in said pan or drum; spraying a syrup containing dissolved lactitol over the rotating bed of cores; drying the sprayed cores with a flow of air so as to cause said lactitol to crystallize as a thin layer on said cores; and repeating the above rotating, spraying and drying steps until a desired thickness of lactitol coating has been obtained, characterized in that said lactitol is caused to crystallize in a lactitol monohydrate-like form and to retain its monohydrate-like form in order to provide a smooth, compact, continuous and stable coating of crystalline lactitol and in order to prevent deterioration of the coating at storage.

2. Process according to claim 1, wherein said lactitol is caused to crystallize in said monohydrate-like form and to retain said monohydrate-like form by providing lactitol monohydrate in the core being sprayed.

3. Process according to claim 2, wherein said lactitol monohydrate in the core is provided by lactitol monohydrate in the core material itself.

4. A process according to claim 3, wherein said lactitol monohydrate in the core comprises pure lactitol monohydrate for controlling the crystallization.

5. Process according to claim 1, wherein said lactitol is caused to crystallize in the monohydrate-like form by providing a crystallization modifier to said lactitol syrup before spraying.

6. Process according to claim 5, wherein said crystallization modifier is selected from gum arabic, gum thala and gelatine.

7. Process according to claim 6, wherein said crystallization modifier is added in an amount of about 1-10%, preferably 2-5% calculated on the weight of the syrup.

8. Process according to claim 1, wherein said monohydrate-like lactitol is caused to retain its monohydrate-like form by preventing or significantly reducing migration of coating-deteriorating compounds from the core into the coating.

9. Process according to claim 8, wherein said deteriorating compounds are selected from sugars, polyols other than lactitol, other sweeteners, and/or other migrating ingredients of the core, such as glycerine.

10. Process according to claim 9, wherein said other polyols are selected from xylitol and sorbitol, and the content of xylitol or sorbitol in the coating is kept at a value below 1%, preferably below 0.5%, most preferably below 0.2%.

11. Process according to claim 8, 9 or 10, wherein said migration is prevented or reduced by precoating said cores with a protective layer prior to the lactitol coating.

12. Process according to claim 11, wherein said precoating is performed with a compound selected from gum arabic, gelatine and shellac.

13. Process according to claim 11 or 12, wherein a powder consisting of seed crystals obtained by milling pure lactitol monohydrate is added to the precoated cores.

14. Process according to claim 1, wherein said lactitol is caused to crystallize in the monohydrate-like form by adjusting the temperature of the syrup to 50 to 70° C., preferably 53 to 65° C., most preferably between 55 and 60° C.

15. Process according to claim 1, wherein said lactitol is caused to crystallize in the monohydrate-like form by adjusting the temperature of the drying air to 20 to 50° C., preferably 25 to 40° C.

16. Process according to claim 1, wherein said lactitol is caused to crystallize in said monohydrate-like form by adjusting the relative humidity of the drying air to below RH 50%.

17. Process according to claim 1, wherein the lactitol concentration of the lactitol syrup is between 55 and 70%, preferably between 60 and 65% calculated on the weight of the syrup.

18. A process according to claim 1, wherein said lactitol syrup contains other additives selected from flavours, pigments, special sweeteners, active ingredients, etc.

19. A process according to claim 18, wherein said syrup contains an additive selected from titanium dioxide, Aspartame and Acesulfame K or mixtures thereof.

20. Process according to claim 1 comprising the steps of
a) providing edible cores containing another sweetener than lactitol;
b) introducing said cores into a coating pan or drum;
c) rotating said cores in said pan or drum;
d) precoating said cores with an aqueous gum arabic solution;
e) adding a powder obtained by milling pure lactitol monohydrate onto said precoated cores;
f) drying said precoating layer with a flow of drying air;
g) spraying a syrup containing dissolved lactitol and gum arabic at a temperature of 50 to 70° C. over the rotating bed of cores;
h) drying the sprayed cores with a flow of dry air having a temperature of 20 to 50° C. so as to cause said lactitol to crystallize as a thin layer of lactitol monohydrate-like coating on said cores; and
i) repeating the above steps g) to h) until a desired thickness of a smooth and compact continuous coating of stable and non-deteriorating monohydrate-like lactitol has been obtained on the cores.

21. An edible core coated with a hard coating of lactitol, characterized in that said lactitol coating comprises a smooth and compact continuous layer of crystalline lactitol which has crystallized during the coating process in a lactitol monohydrate-like form for providing stability of the coating and for preventing deterioration of the coating at storage.

22. Edible core according to claim 21, wherein said lactitol monohydrate-like coating contains a crystallization modifier comprising gum arabic, gum thala or gelatine.

23. Edible core according to claim 21, wherein said core contains a sweetener other than lactitol and contains a protective precoating between said core and said lactitol monohydrate-like coating layer.

24. Edible core according to claim 23, wherein said precoating comprises a layer of gum arabic, gelatine or shellac.

25. Edible core according to claim 20, wherein said coating contains less than 1%, preferably less than 0.5%, most preferably less than 0.1% of another polyol than lactitol, such as xylitol or sorbitol.

26. Edible core according to claim 21, wherein said core is a chewing gum, a chewable tablet, a candy, an almond, or the like.
